(19) United States
(12) Patent Application Publication
(10) Pub. No.: US 2024/0105146 A1
(43) Pub. Date: Mar. 28, 2024

(54) CELLO ENDPIN

(71) Applicant: Seong-woo CHO, Jeonju-si (KR)

(72) Inventor: Seong-woo CHO, Jeonju-si (KR)

(21) Appl. No.: 17/767,659

(22) PCT Filed: Sep. 8, 2020
(86) PCT No.: PCT/KR2020/012120

§ 371 Date: Apr. 8, 2022

(30) Foreign Application Priority Data
Oct. 8, 2019 (KR) 10-2019-0124905

(51) Int. Cl. G10D 3/01

(52) U.S. Cl. CPC G10D 3/01

(57) ABSTRACT

The present invention relates to a cello endpin, and a cello support frame constituting a core part of the endpin comprises an inner part formed from a metal rod made of brass and an outer part formed from a carbon pipe.

### TECHNICAL FIELD

The present invention relates to a cello endpin, and more particularly, to a cello endpin capable of easily dissipating vibration generated when playing a cello to thus stabilize sound, while maximizing convenience when a player plays the cello.

### BACKGROUND ART

In general, a cello is classified as a medium/large instrument with heavy load rather than a small instrument such as a violin or guitar. Accordingly, a player cannot hold the cello with the hands during performance, but a manner such that an endpin provided on a lower portion of the cello is supported on the floor while securing/supporting a body of the cello with the knees of the player has become popular.

Further, the conventional endpin is made of wood or metal, and a diaphragm is attached to a part where the endpin contacts the body of a cello so that a length of the cello can be adjusted depending on the height of a player. Further, the endpin is inserted into the cello for the purpose of minimizing the length when the player moves after finishing the performance.

However, in the case of playing the cello provided with the conventional endpin, vibration is transmitted to the floor through the endpin so that the sound varies according to the condition of the floor and, if the floor of a concert hall where the player plays the cello is slippery, there is a problem of sliding along the surface of the floor.

### DISCLOSURE

### Technical Problem

The present invention is proposed to solve the above problems, and an object of the present invention is to provide a cello endpin that not only achieves convenience of a player by simply supporting a heavy cello on the ground, but also can easily adjust a length of the cello, and that is provided with a metal rod made of brass in the core thereof so as to maximize sound effects of the cello.

### Technical Solution

With regard to a cello endpin according to an embodiment of the present invention in order to solve the above problem, a cello support frame to constitute a core of the endpin may be characterized in that an inner portion consists of a metal rod made of brass while an outer portion consists of a carbon pipe.

In this regard, the cello endpin may include: a coupling member inserted into a lower portion of the cello; a cello support frame inserted into the coupling member; and an endpin provided at an end of the cello support frame, wherein the coupling member includes: an upper protrusion that protrudes inside the cello while having an inclined side cross-section; a lower protrusion that protrudes outside the cello; a groove provided around a circumference (the periphery) of the coupling member, which is spaced at a predetermined length in a longitudinal direction of the cello support frame and enables a tailpiece string to hang around the coupling member; and a length adjustment means to adjust the length of the cello support frame. Further, the cello endpin may further include: a first housing that is inserted into the cello by a predetermined depth, forms a coupling part in a shape corresponding to the upper protrusion and thus is coupled to the upper protrusion, and is provided with a vibration-proof member between the first housing and the upper protrusion; and a second housing into which the lower protrusion is inserted and which has an end formed to be fixed to the cello support frame, wherein a fixing force of the end is controlled when adjusting the length of the cello support frame by the length adjustment means.

Further, the endpoint of the present invention may be used for cellos provided with different endpin coupling parts, which are formed by coupling first housings having different diameters to the upper protrusion, respectively.

Further, the vibration-proof member may be composed of any one of silicon or ethylene vinyl acetate.

Further, the metal rod may be made of any one or more of brass, aluminum, titanium, tungsten, stainless steel and copper.

Further, the length adjustment means may include: a length adjustment clamp provided to surround the cello support frame; and a fastener capable of tightening and loosening the length adjustment clamp.

Further, the length adjustment means may be provided around the cello support frame so as to be inserted into the coupling member, and may have an end formed to be tightened by the end of the second housing.

Further, the endpin may be characterized in that the end is provided in a sharp point shape.

Further, the cello endpin may further include a non-slip member inserted into the end of the endpin.

In addition, the non-slip member may be formed of any one of wool pad, nonwoven fabric and rubber, and may have protrusions formed on the surface thereof.

### Advantageous Effects

The cello endpin according to an embodiment of the present invention is provided in a structure capable of being disassembled/coupled, therefore, when an abnormality occurs in the structure provided in the embodiment of the present invention, a cello endpin, which is easy to install and replace, may be provided so as to achieve effects of improving convenience of a player.

Further, the cello endpin according to an embodiment of the present invention has advantages that a position of the vibration-proof member may be altered according to the request of the player, and thus, may be provided in any desired position suitable for the needs of the player.

In addition, like a change of position, the cell endpin according to an embodiment of the present invention has a structure that is detachable/attachable, and can be varied or deformed in different forms, thereby improving use efficiency and being advantageous in maintenance.

### DESCRIPTION OF DRAWINGS

FIG. 1 is a perspective view of a cello.

FIG. 2 is a perspective view of the cello endpin according to an embodiment of the present invention.

FIG. 3 is an exploded perspective view of the cello endpin according to an embodiment of the present invention.

FIG. 4 is an inner cross-sectional view of the cello endpin according to an embodiment of the present invention.

FIG. 5 is a perspective view of the cello endpin provided with a length adjustment means according to an embodiment of the present invention.

FIG. 6 is an exploded and combined view of the cello endpin provided with a length adjustment means according to an embodiment of the present invention.

FIG. 7 is an inner cross-sectional view of the cello endpin provided with a length adjustment means according to an embodiment of the present invention.

FIG. 8 is a perspective view of the cello endpin provided with a non-slip member according to an embodiment of the present invention.

### BEST MODE

Hereinafter, the description of the present invention with reference to the drawings is not limited to specific embodiments, and various modifications may be applied and various embodiments may be provided. Further, the content described below should be understood to include all conversion, equivalents and substitutes included in the spirit and scope of the present invention.

In the following description, terms such as first, second, etc. are terms used to explain various elements, and their meanings are not limited but used only for the purpose of distinguishing one element from other elements.

The same reference numerals used throughout the present specification indicate the same elements.

The singular expression used in the present invention includes a plurality of expression unless clearly indicated otherwise in the context. Further, terms such as “include”, “provided” or “have” below are intended to designate the presence of features, numbers, steps, actions, components, parts or combinations thereof described in the specification. It is to be construed and not to preclude the possibility of the presence or addition of one or more other features, numbers, steps, actions, components, parts or combinations thereof.

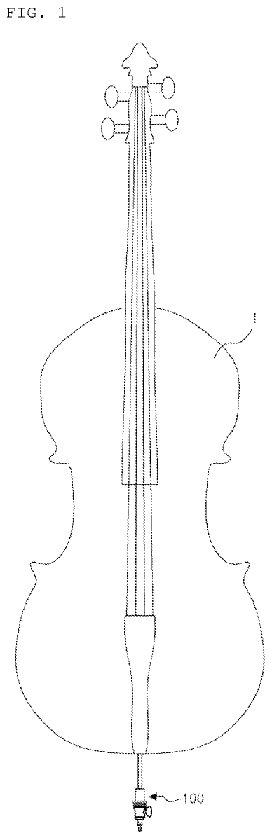

Hereinafter, a cello endpin according to an embodiment of the present invention will be described in detail with reference to FIGS. 1 to 8.

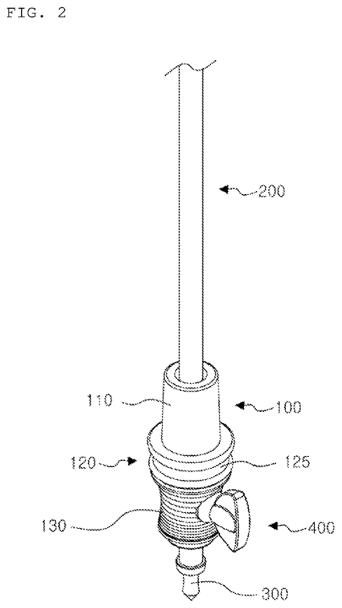

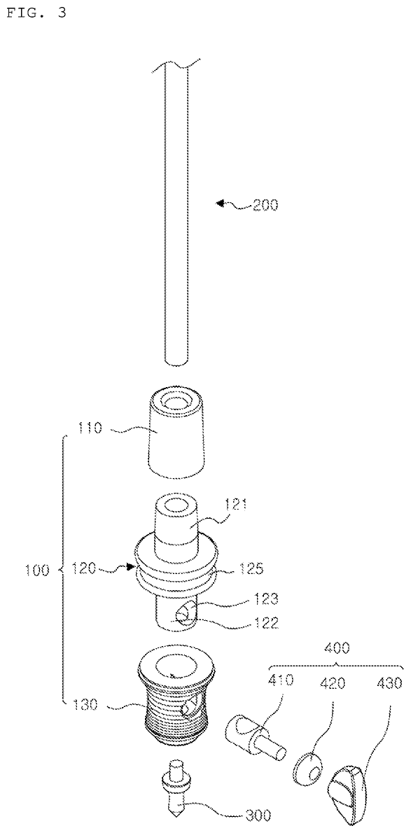

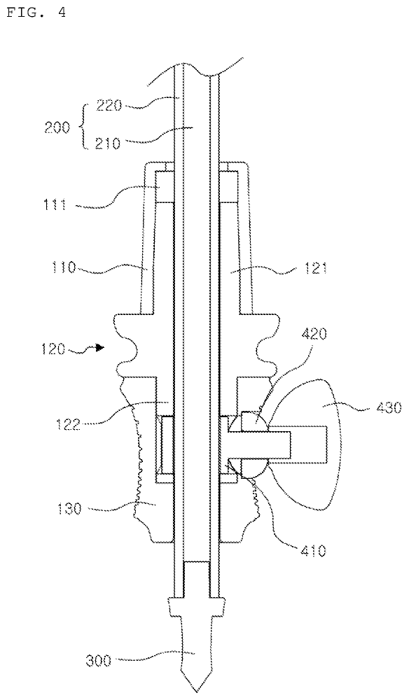

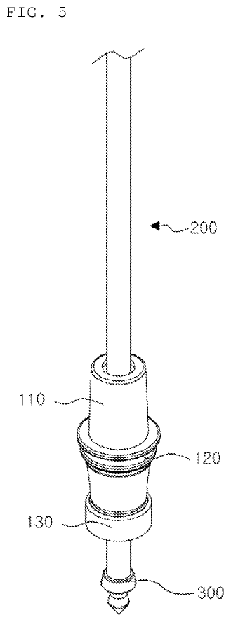

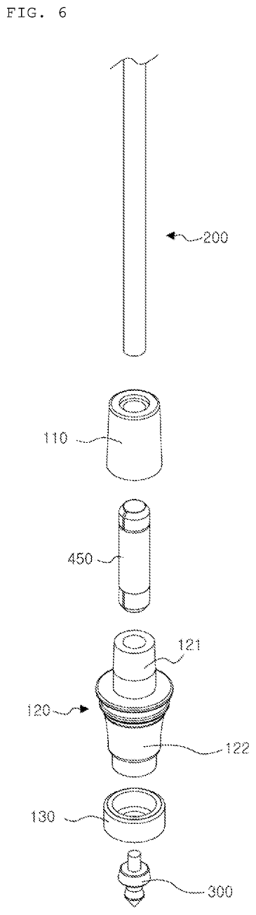

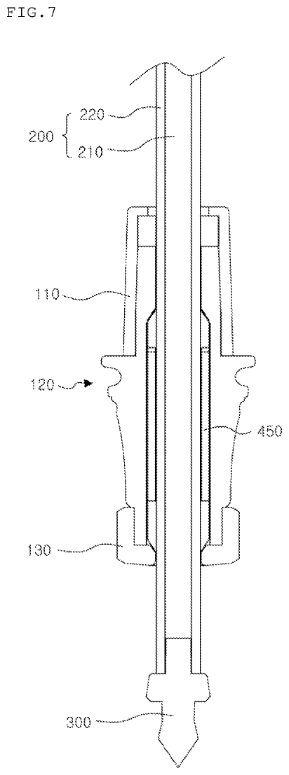

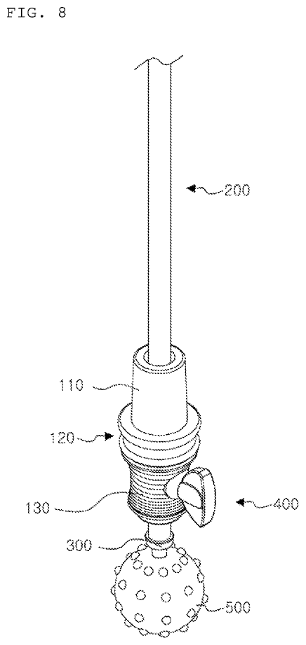

FIG. 1 is a perspective of a cello. Specifically, FIG. 1 is a perspective view of a cello; FIG. 2 is a perspective view of the cello endpin according to an embodiment of the present invention; FIG. 3 is an exploded perspective view of the cello endpin according to an embodiment of the present invention; FIG. 4 is an inner cross-sectional view of the cello endpin according to an embodiment of the present invention, wherein a length is adjustable by an insertion part and a fitting part; FIG. 5 is a perspective view of the cello endpin provided with a length adjustment means according to an embodiment of the present invention; FIG. 6 is an exploded and combined view of the cello endpin provided with a length adjustment means according to an embodiment of the present invention; FIG. 7 is an inner cross-sectional view of the cello endpin provided with a length adjustment means according to an embodiment of the present invention; FIG. 8 is a perspective view of the cello endpin provided with a non-slip member according to an embodiment of the present invention.

First, referring to FIG. 1, the cello will be described as follows.

A body of the cello is mainly made of maple, which is a strong material, and recently, materials such as carbon fiber or aluminum are used.

Meanwhile, the cello is an instrument with middle-low sound and, in most cases, is longer than 1 meter in length. Therefore, a method of playing the cello is characterized in that a player stands up the instrument between the knees while sitting on a chair in order to play the same, and the cello has a characteristic of including an endpin for supporting the instrument on the floor.

Meanwhile, referring to FIGS. 2 to 4, the cello endpin 100 according to an embodiment of the present invention may include a cello support frame 200, and the cello support frame 200 may be configured to include a metal rod 210 and a carbon pipe 220.

Specifically, the metal rod 210 may be inserted into a core of the cello support frame 200, and the carbon pipe 220 surrounding the metal rod 210 may be provided.

In this regard, the metal rod 210 is preferably made of brass.

On the other hand, if a metal provided in the core of the cello support frame 200 is brass, advantages of low-pitched vibration and abundant damping sound which are required for the cello may be attained. However, since the brass does not have fast attenuation of the vibration transmitted from the cello, accumulation of vibration occurs during continuous performance of the player, hence occasionally causing a problem in which clean sound is not produced.

Accordingly, the cello endpin according to an embodiment of the present invention is provided with a carbon material pipe to surround the surface of the metal rod 210, thereby attenuating unnecessary vibration generated from the metal rod 210.

As such, carbon with excellent damping ability may be integrally provided in the metal rod 210 so as to attenuate undesirable vibration transmitted from the metal rod 210 while retaining residual vibration inside the metal rod, thereby creating a rich, stable and beautiful sound.

Further, since the carbon has excellent strength, there is an effect of preventing the metal rod 210 or the cello support frame 200 from being bent as it is due to the continuous load caused by the cello.

Alternatively, the metal rod 210 may be formed of any one or more of aluminum, titanium, tungsten, stainless steel and copper.

That is, the metal rod 210 may be formed of any one or more of brass, aluminum, titanium, tungsten, stainless steel and copper.

Further, the metal rod 210 is not limited to one material, but may be formed by mixing the above described materials. That is, the metal rod may be formed by mixing brass and titanium or by mixing tungsten and aluminum.

In order to assist a player to have performance suitable for required situation, the metal rod 210 provided in the core of the cello support frame 200, which is formed of various materials, instead of the endpin made of one material, has been developed according to the needs for enabling performance suitable for situation.

For example, when the material of the metal rod 210 includes titanium, the cello may have features of having a clear pitch and enabling accurate performance. In the case of tungsten, the cello may have advantages of a sound with no large flow width and being excellent in high notes.

On the other hand, looking at a structure of the cello endpin which includes the cello support frame 200 composed of the metal rod 210 and the carbon pipe 220 according to the embodiment of the present invention as described above in more detail, a coupling member 120, a cello support frame 200, a first housing 110, a second housing 130 and an endpin 300 may be included.

Specifically, the coupling member 120 is provided on a lower portion of the cello 1 and, at this time, the coupling member 120 may have a hollow part in order to insert the cello support frame 200 therein.

Further, the cello support frame 200 is preferably provided in a cylindrical rod shape as shown in the drawing, but is not limited thereto. Alternatively, it may also be provided in a polygonal shape.

Further, the endpin 300 may be inserted/coupled at the end of the cello support frame 200.

As such, the coupling member 120 may include an upper protrusion 121, a lower protrusion 122, a groove 125 and a length adjustment means 400.

First, the upper protrusion 121 protrudes to the inside of the cello 1 and may have an inclined side cross-section, whereby the coupling member can be easily pulled out from the bottom of the cello when the cello endpin 100 is damaged or a situation requiring replacement occurs.

However, the upper protrusion 121 has such an inclined cross-section as a preferable example, although the side cross-section may also be formed in a rectangular shape without being necessarily limited to the above shape having an inclined side cross-section.

Further, the lower protrusion 122 protruding to the outside of the cello may be provided to couple the second housing 130 described later, and may include a clamp insertion part 123 so that the length adjustment means 400 to adjust a length of the cello support frame can be fastened.

Further, the groove 125 is spaced at a predetermined length in a longitudinal direction of the cell support frame 200, and may be provided around the periphery of the coupling member 120 so as to hang a tail piece string around the coupling member.

To the coupling member 120 described above, the first housing 110 and the second housing 130 may be coupled. Specifically, the first housing 110 may include a coupling part, which is inserted into the cello 1 by a predetermined depth and has a shape corresponding to the upper protrusion 121 of the coupling member 120 so as to be coupled to the upper protrusion 121, and a vibration-proof member 111 provided between the first housing and the upper protrusion 121.

Further, each of the first housings 110 having different diameters is able to be coupled and used to the upper protrusion 121 so that the cello endpin of the present invention may be effectively used for cellos formed with different endpin coupling parts.

At this time, the second housing 130 may be formed such that the lower protrusion 122 is inserted therein, an end of the second housing is secured to the cello support frame 200, wherein a fixing force of the end can be controlled when adjusting the length of the cello support frame by the length adjustment means 400.

Further, the second housing 130 may prevent the coupling member 120 from being pushed downward while playing the cello, thereby reinforcing the fixing force.

Meanwhile, the vibration-proof member 111 may be made of any one of silicon or ethylene vinyl acetate.

In this case, silicon and ethylene vinyl acetate (EVA) are easy to mold and have an advantage of effectively reducing vibration, but are not limited thereto. That is, all materials useable for preventing vibration may be included.

Further, the length adjustment means 400 may be provided to adjust a length of the cello support frame 200, and may include a length adjustment clamp 410 to surround the cello support frame 200 and a fastener 430 provided at a lateral side in order to tighten and release the length adjustment clamp 410, as well as a cover 420 between the clamp 410 and the fastener 430.

As a result, loosening or tightening the fastener 430 may pull out the cello support frame 200 provided inside the cello 1 or secure the same while maintaining a predetermined length.

Prior to describing the cello endpin according to the present embodiment, first, the lower protrusion 122 included in the coupling member 120 according to the above described embodiment includes a clamp insertion part 123 and the second housing 130 has a hollow part. However, the lower protrusion 122 and the second housing 130 according to the embodiment described later may also be formed with omitting the configuration of the clamp insertion part 123 and the hollow part.

Hereinafter, referring to FIGS. 5 to 7, the length adjustment means 450 may be formed in a longitudinal direction around the cello support frame 200 and provided between the cello support frame 200 and the coupling member 120.

On the other hand, the second housing 130 may be formed such that the lower protrusion 122 is inserted therein and an end of the second housing is secured to the cello support frame 200, wherein a fixing force of the end can be controlled when adjusting the length of the cello support frame by the length adjustment means 450.

Herein, the length adjustment means 450 is provided around the cello support frame 200 so as to be inserted into the coupling member 120, and an end of the length adjustment means may be formed to be fastened by the end of the second housing 130.

Further, the coupling member 120 may be provided with a predetermined diameter larger than a diameter of the cello support frame 200 so as to be movable in the longitudinal direction of the cello support frame 200.

Therefore, if a player wants to adjust a length of the cello support frame 200, the cello support frame 200 with a fixed length becomes movable by pulling out the second housing 130 from the coupling member 120.

Further, the endpin 300 may be characterized in that the end thereof has a sharp point shape.

The above endpin makes it easy for the player to stand up the cello 1 with the endpin 300 on the floor, and therefore, is provided for convenience in performance.

Meanwhile, the end of the endpin 300 preferably has a sharp point shape as shown in the drawings. However, the end is not necessarily limited to such a point shape, but may have a circular shape or a cylindrical shape with a taper at an edge portion thereof.

Further, referring to FIG. 8, the cello endpin 100 may further include a non-slip member 500.

Specifically, the non-slip member 500 may be inserted into the end of the endpin 300 as shown in FIG. 8.

This is to prevent the endpin 300 from slipping while the player plays the cello 1 by increasing the coefficient of friction of a surface on which the non-slip member 500 is in contact with the floor.

At this time, the non-slip member 500 may include all kinds of materials used for non-slipping such as wool pad, non-woven fabric, rubber, and the like.

Further, in order to further exhibit non-slip effects, the non-slip member may be characterized in that a protrusion protruding from the surface is formed.

In addition, the non-slip member 500 is preferably formed in a spherical shape as shown in the drawings, but is not necessarily limited to such a circular shape. Instead, a semicircle shape with a flat surface formed to face the cello or a cylindrical shape having an angle formed at an edge portion thereof may also be adopted.

The embodiments of the present invention have been described with reference to the accompanying drawings, but those skilled in the art to which the present invention pertains would understand that the present invention can be implemented in other specific forms without changing the technical spirit or essential features of the present invention. Therefore, the embodiments described above are illustrative and non-limiting in all aspects.

1. A cello endpin, comprising:
a cello support frame to constitute a core of the endpin,
wherein the cello support frame includes an inner portion consisting of a metal rod made of brass, and an outer portion consisting of a carbon pipe.

2. The cello endpin according to claim 1, further comprising:
a coupling member inserted into a lower portion of the cello;
the cello support frame inserted into the coupling member; and
an endpin provided at an end of the cello support frame,
wherein the coupling member includes:
an upper protrusion that protrudes inside the cello while having an inclined side cross-section;
a lower protrusion that protrudes outside the cello;
a groove provided around a circumference (the periphery) of the coupling member, which is spaced at a predetermined length in a longitudinal direction of the cello support frame and enables a tailpiece string to hang around the coupling member; and
a length adjustment means to adjust the length of the cello support frame,
wherein the cello endpin further includes:
a first housing that is inserted into the cello by a predetermined depth, forms a coupling part in a shape corresponding to the upper protrusion and thus is coupled to the upper protrusion, and is provided with a vibration-proof member between the first housing and the upper protrusion; and
a second housing into which the lower protrusion is inserted and which has an end formed to be fixed to the cello support frame, wherein a fixing force of the end is controlled when adjusting the length of the cello support frame by the length adjustment means.

3. The cello endpin according to claim 2, wherein the cello endpin is also useable for cellos provided with different endpin coupling parts, which are formed by coupling first housings having different diameters to the upper protrusion, respectively.

4. The cello endpin according to claim 2, wherein the vibration-proof member is composed of any one of silicon or ethylene vinyl acetate.

5. The cello endpin according to claim 1, wherein the metal rod is made of any one or more of brass, aluminum, titanium, tungsten, stainless steel and copper.

6. The cello endpin according to claim 2, wherein the length adjustment means includes:
a length adjustment clamp provided to surround the cello support frame; and
a fastener capable of tightening and loosening the length adjustment clamp.

7. The cello endpin according to claim 2, wherein the length adjustment means is provided around the cello support frame so as to be inserted into the coupling member, and has an end formed to be tightened by the end of the second housing.

8. The cello endpin according to claim 1, wherein an end of the endpin is provided in a sharp point shape.

9. The cello endpin according to claim 1, further comprising:
a non-slip member inserted into an end of the endpin.

10. The cello endpin according to claim 9, wherein the non-slip member is formed of any one of wool pad, nonwoven fabric and rubber,
wherein a protrusion is formed on a surface thereof.
